(19) United States
(12) Patent Application Publication
(10) Pub. No.: US 2012/0131554 A1
(43) Pub. Date: May 24, 2012

(54) CONTROLLING PERFORMANCE AND SCALABILITY OF A SOFTWARE APPLICATION DURING DEVELOPMENT

(76) Inventors: WOLFGANG MUELLER, Wiesloch (DE); Veit Bolik, Frankenthal (DE); Christian Mohr, Wiesloch (DE)

(21) Appl. No.: 12/952,334

(22) Filed: Nov. 23, 2010

(51) Int. Cl. G06F 9/44

(52) U.S. Cl. 717/124

(57) ABSTRACT

Various embodiments of systems and methods for controlling a performance and scalability of a software application during development are described herein. A method includes generating a test environment to repeatedly trigger a test on an executable software module from a beginning of a development phase. In response to triggering, reading a set of input data, evaluating a measurement result corresponding to each input data, determining a relation of the measurement results as one of a linear and a non-linear relative to the set of input data, and initiating a corrective action for the software module if the non-linear relation is determined. The method employs the linearity (linear and non-linear relation) as a key performance indicator (KPI) to control the performance and/or scalability of the software module during development. A repetitive and/or regular testing of performance and scalability using the linearity as KPI while developing the application ensures a high performance complaint and scalable application after development.

### FIELD

The technical field relates to performance and scalability of a software application.

### BACKGROUND

Software application is developed considering a number of parameters, e.g., an end user's requirements, technical requirements (e.g., a platform on which the software application would execute), business requirements, etc. Usually, the requirements include a constraint on productivity (i.e., output/input) of the software application. For example, if the software application is meant for generating invoices then the constraint on productivity may be 100 invoices (output) per second (input). If the software application satisfies the constraint (output/input) it is said to be a compliant. Testing is performed to assure (verify and validate) if the software application is compliant (i.e., satisfies the constraint).

Once it is determined that the software application is compliant, the testing may be extended to determine if the performance of the software application is constant/predictable with a varying configuration or environment, e.g., increasing load, addition of hardware components, etc. Scalability measures the behavior (trend) of performance with the varying environment. Essentially, the testing determines if the software application scales, i.e., if the behavior (performance) of the software application is predictable or definite with the varying environment. For example, if the software application takes 1 second to generate 100 objects, 10 seconds to generate 1000 objects, 100 seconds to generate 10000 objects and so on then the software application scales, i.e., the behavior of the software application is predictable and it may be predicted that for generating 2000 objects the software application would take 20 seconds. Usually, the testing for the performance and scalability is performed once the software application is developed, prior to shipping/deployment.

However, testing after completion of the development phase carries a significant degree of risk that serious performance and/or scalability defects appearing during development may remain unidentified. Usually, the developed software application includes a voluminous amount of code and it becomes difficult to precisely detect (identify) problematic code (causing the performance and/or scalability defects). Further, it may be troublesome to resolve the detected performance and/or scalability defects without significant application reworking. Again, the reworking of the software application is time consuming and complicated.

Additionally, the ramification of having defects prior to shipping may further delay the release of the application. Furthermore, if the application is deployed with significant performance and/or scalability defects it may require costly and time consuming remedial work after deployment. Even worse, the application might have to be withdrawn from circulation. All of these outcomes may have a negative effect on the business and on the confidence of the end user who is expected to use the application.

It would be desirable, therefore, to provide a system and method for improving performance and scalability that obviates the above mentioned problems.

### SUMMARY OF THE INVENTION

Various embodiments of systems and methods for controlling performance and scalability of a software application during its development phase are described herein. In one aspect, a tool is installed on a computer system to generate a test environment to repeatedly trigger a test on an executable software module. In response to triggering, the tool reads a set of input data. A measurement result corresponding to each input data of the set of input data is evaluated. The measurement result may be evaluated by measuring a resource consumption of the software module, e.g., memory consumption, process time, database access time consumption, etc. A relation of the measurement results relative to the set of input data is determined. The relation may be one of a linear and a non-linear. If the relation of the measurement results relative to the set of input data is the non-linear, the tool initiates a corrective action for the software module. A repetitive and/or regular investigation of linearity (linear and non-linear relation) from a beginning of a development phase ensures a highly performant and scalable software application after development.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a system including a tool for controlling performance and scalability of a software module during its development phase, according to an embodiment.

FIG. 2 illustrates an exemplary graph representing a linear relation of measurement results relative to a set of input data, according to an embodiment.

FIG. 3 illustrates an exemplary graph representing a non-linear relation of measurement results relative to the set of input data, according to an embodiment.

FIG. 4 illustrates an exemplary graph representing repetitive tests performed on the software module at a predefined time interval, according to an embodiment.

FIG. 5 illustrates an exemplary graph representing the behavior of the software module that comprises an executable method of a business object (BO), according to an embodiment.

FIG. 6 illustrates an exemplary graph representing the behavior of the software module that comprises a plurality of methods from a plurality of BOs, according to an embodiment.

FIG. 7 is a flow chart illustrating the steps performed to control the performance and scalability of the software module during the development phase, according to various embodiments.

FIG. 8 illustrates the steps performed to determine the relation of the measurement results relative to the set of input data using a graphical approach, according to an embodiment.

FIG. 9 illustrates the steps performed to determine the relation of the measurement results relative to the set of input data using a mathematical approach, according to another embodiment.

FIG. 10 is a block diagram of an exemplary computer system, according to an embodiment.

### DETAILED DESCRIPTION

Embodiments of techniques for controlling performance and scalability of a software application during its development phase are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

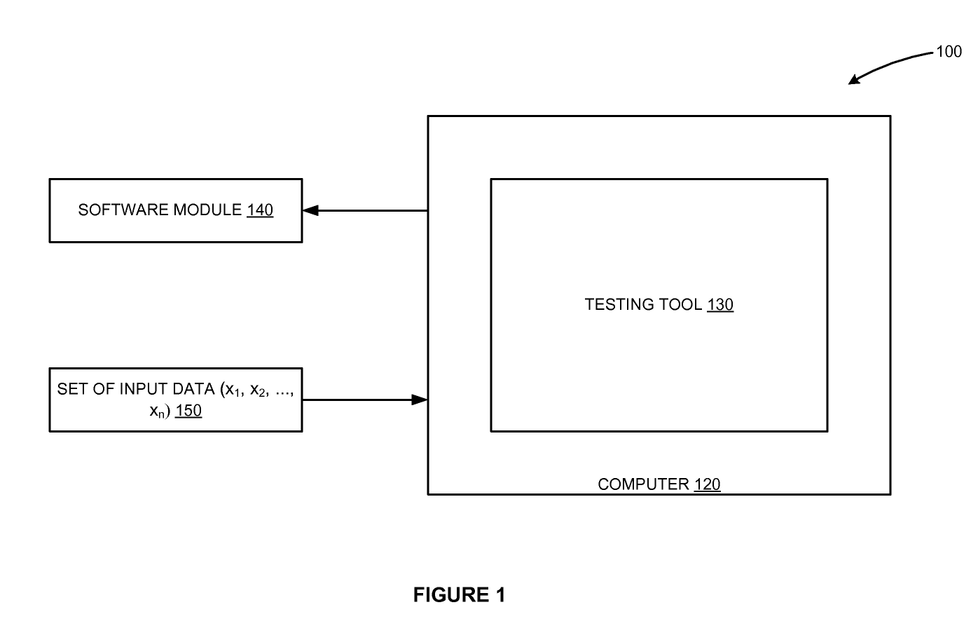

FIG. 1 illustrates one embodiment comprising a system 100 for controlling performance and/or scalability of a software application during development. The system 100 includes a testing tool 130 installed on a computer 120 to test an executable software module 140. The testing tool 130 generates a test environment that repeatedly triggers a test on the software module 140. Once the test is triggered, the testing tool 130 reads a set of input data (x₁, x₂, . . . , xₙ) 150 and determines a behavior of the software module 140 relative to the set of input data (x₁, x₂, . . . , xₙ) 150. Essentially, the behavior of the software module 140 is determined by evaluating a measurement result corresponding to each input data from the set of input data (x₁, x₂, . . . , xₙ) 150, e.g., by measuring a resource consumption of the software module 140. A relation of measurement results relative to the set of input data (x₁, x₂, . . . , xₙ) 150 may be determined. The relation may be a linear or a non-linear. If the non-linear relation is determined, a corrective action is initiated by the testing tool 130 for the software module 140.

The software module 140 may be a software application still under development. Essentially, the software module 140 may be any executable entity developed during the development phase of the software application, e.g., a function, a table, a class, an interface, a method, a user interface, an object generated by at least one of the class and the interface, a business object, and a functional unit generated by a plurality of business objects to perform a specific task. In one embodiment, the software module 140 may be a combination of any of the function, the table, the class, the interface, the method, the object, the business object, and the functional unit. In another embodiment, the software module 140 is any executable section of code generated while developing the software application. The software module 140 may be tested by the testing tool 130.

The testing tool 130 generates the test environment to repeatedly trigger the test on the software module 140. The test may be triggered automatically by the testing tool 130 or manually by a user (e.g., by a developer or a person authorized to perform the test). In one embodiment, the testing tool 130 may keep track of the software module 140 (software application under development) and automatically triggers the test responsive to a change in the software module 140. The change may be due to addition of new lines of code or modification(s) to the existing lines of code. In another embodiment, the testing tool 130 may automatically trigger the test at a predefined time interval (e.g., after every 24 hours or on a daily basis). The predefined time interval may be modifiable by the user.

Once the test is triggered, the testing tool 130 reads the set of input data (x₁, x₂, . . . , xₙ) 150. The set of input data (x₁, x₂, . . . , xₙ) 150 defines a countable result that has to be generated by the software module 140, e.g., a number of objects that has to be generated by the software module 140. Essentially, the set of input data (x₁, x₂, . . . , xₙ) 150 is a scale value (data volume) that indicates the number of objects to be generated or processed by the software module 140. The set of input data (x₁, x₂, . . . , xₙ) 150 may be defined by the user prior to initiating the test on the software module 140.

The software module 140 is tested by determining the measurement result corresponding to each input data (x₁, x₂, . . . , xₙ) 150. The measurement result may be time and/or resources consumed (utilized) while executing the software module 140, e.g., the measurement result may be any one of a runtime, a CPU utilization, a memory consumption, a database time, a database byte transfer, processing time, and a CPU runtime. Essentially, the relation of the measurement results relative to the set of input data (x₁, x₂, . . . , xₙ) 150 is determined. The relation may be one of linear and non-linear.

The relation of the measurement results relative to the set of input data (x₁, x₂, . . . , xₙ) 150 may be determined by executing the software module 140 for each input data (x₁, x₂, . . . , xₙ) 150. A value of the measurement result corresponding to each input data (x₁, x₂, . . . , xₙ) 150 is captured. For example, the software module 140 may be executed for the first input data x₁ and the corresponding value of the measurement result (e.g., runtime or time taken by the software module 140 to execute x₁) may be captured as y₁ and so on. Based upon the captured values of the measurement results (y₁, y₂, . . . , yₙ), the relation of the measurement results relative to the set of input data (x₁, x₂, . . . , xₙ) 150 may be determined as linear or non-linear. The relation may be determined by a graphical or a mathematical approach. In one embodiment, the combination of the graphical and the mathematical approach may be used for determining the relation of the measurement results (y₁, y₂, . . . , yₙ) relative to the set of input data (x₁, x₂, . . . , xₙ) 150.

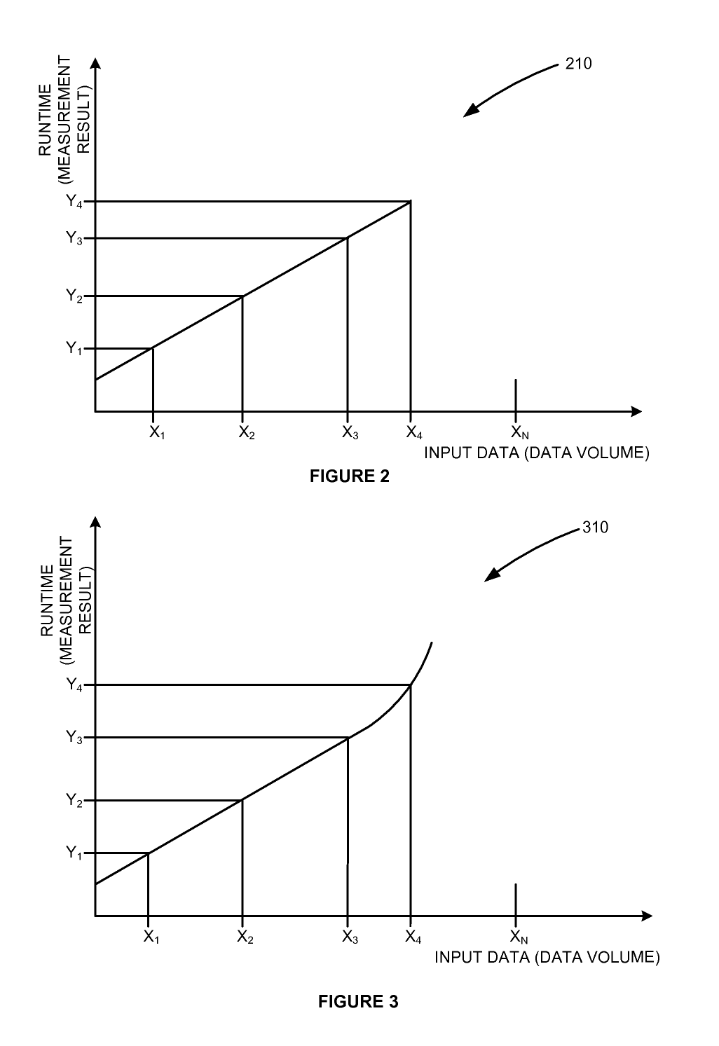

In the graphical approach, a graph may be plotted between the set of input data (x₁, x₂, . . . , xₙ) 150 and the captured values of the measurement results (y₁, y₂, . . . , yₙ) (e.g., runtime). The graph may be linear 210 (refer to FIG. 2) or non-linear 310 (refer to FIG. 3). If the graph is linear 210 the linear behavior is determined. The linear graph 210 includes a perfect straight line. Alternately, if the graph is non-linear 310 the non-linear behavior is determined. The non-linear graph 310 includes a line that is not straight (e.g., curved, etc). Essentially, the non-linear graph includes a curve defined by a polynomial function (excluding a logarithmic function). In one embodiment, the graph may be displayed on a user interface device.

In the mathematical approach, the relation of the measurement results relative to the set of input data (x₁, x₂, . . . , xₙ) 150 may be determined by calculating an ideal values of the measurement results (y₁′, y₂′, . . . , yₙ′) for the corresponding input data (x₁, x₂, . . . , xₙ) 150. Essentially, the ideal values of measurement result (y₁′, y₂′, . . . , yₙ′) may be calculated by using the formula:

yᵢ=axᵢ+b,

wherein i=1→n; yᵢ′ is the ideal value of the measurement result; axᵢ is the value of input data; and a and b are predefined constants determined theoretically considering a perfect linear relation of the measurement results relative to the set of input data (x₁, x₂, . . . , xₙ) 150.
Essentially, the constant ‘a’ and ‘b’ are pre-determined by using a perfect line formula y=ax+b. Typically, the ideal value (expected value) of y (e.g., response time) is known for the value of x (input data) therefore at least two values of x and their corresponding expected value of y may be used in the formula y=ax+b to determine the value of a and b. The value of a and b, determined by considering the linear relation of the measurement results relative to the set of input data (x₁, x₂, . . . , xₙ) 150, may be stored in the memory storage device. The stored value of ‘a’ and ‘b’ may be used to calculate the ideal values of the measurement result (y₁′, y₂′, . . . , yₙ′) corresponding to each input data (x₁, x₂, . . . , xₙ) 150 using the formula yᵢ′=axᵢ+b. Once the ideal values of the measurement result (y₁′, y₂′, . . . , yₙ′) are determined, a ratio is calculated between the ideal values of the measurement result (y₁′, y₂′, . . . , yₙ′) and the corresponding captured value of the measurement result (y₁, y₂, . . . , yₙ). For example, the ratio (i.e., y₁′/y₁, y₂′/y₂, . . . , yₙ′/yₙ) may be obtained. Each ratio is compared to a numerical value 1. If one or more ratio is less than 1 (i.e., the ideal value≠the captured value), the non-linear relation is determined.

Once the non-linear relation is determined, the testing tool 130 initiates the corrective action (optimization action). The corrective action may include generating an alert to inform a responsible party about the non-linear relation of the measurement results (y₁, y₂, . . . , yₙ) relative to the set of input data (x₁, x₂, . . . , xₙ) 150. The alert may be sent automatically to the responsible party (e.g., via an email). Upon receiving the alert the responsible party may manually trigger a workflow to determine the non-linear coding section(s) within the software module 140 to rectify the non-linear relation. In another embodiment, the corrective action may include automatically executing the workflow to identify one or more non-linear coding sections within the software module 140. Essentially, the testing tool 130 may be integrated with the workflow, e.g., s30, etc to identify one or more non-linear coding sections within the software module 140. Once the non-linear coding section is identified, the testing tool 130 may automatically send the email to the responsible party about the identified non-linear coding section(s).

After receiving the email (alert), the responsible party may fix (rectify) the non-linear coding section. The responsible part may be an individual or a team that developed the non-linear coding section.

The test for determining the relation the relation of the measurement results (y₁, y₂, . . . , yₙ) relative to the set of input data (x₁, x₂, . . . , xₙ) 150, as illustrated in FIGS. 2-3 is triggered automatically by the testing tool 130 or manually by a user (e.g., by a developer or a person authorized to perform the test). In one embodiment, the testing tool 130 may trigger the test responsive to a change in the software module 140. Essentially, the test is triggered at the predefined time interval (e.g., after every 24 hours or on the daily basis).

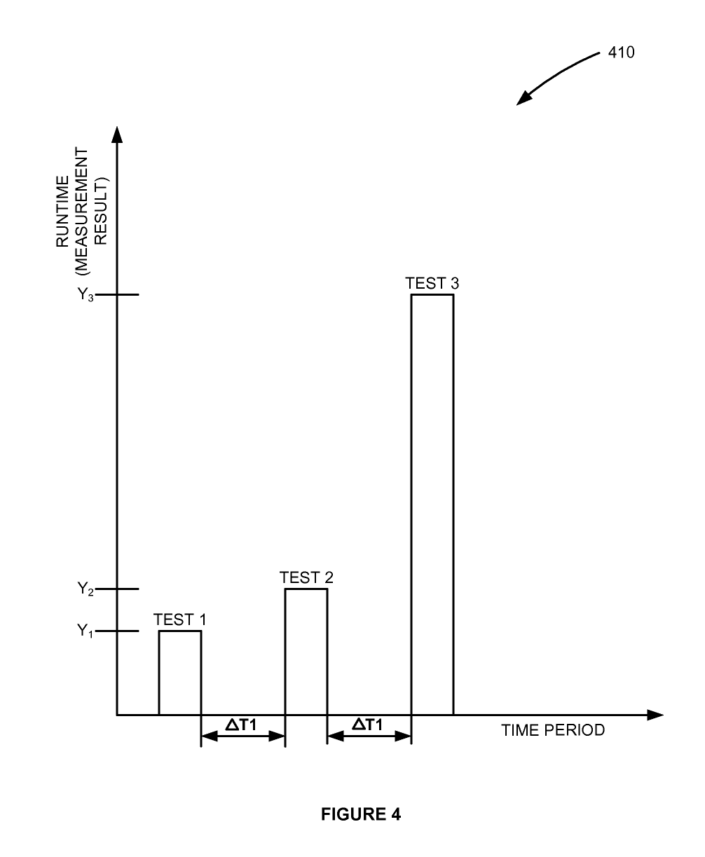

In one embodiment, as illustrated in FIG. 4, a graph 410 may be plotted based on the successive (repetitive) tests (1-3) performed on the software module 140. Essentially, the successive tests (1-3) may be performed after the predetermined time period Δt1 (e.g., after every 24 hours). For example, the test 1 may be performed by executing the software module 140 for the input data (e.g., x₁) and capturing the measurement result y₁, the test 2 may be performed after the predefined time interval Δt1 (e.g., 24 hours) by executing the software module 140 for the same input data (x₁) and capturing the measurement result y₂, similarly, test 3 may be performed after the predefined time interval Δt1 (24 hours) and the value y₃ may be captured. The graph 410 may be plotted keeping the predetermined time period Δt1 between the successive test (1-3) on the x axis (different point on the x axis that are 24 hrs apart, i.e., Δt1=24 hrs) and the values of the measurement result (y₁, y₂, and y₃) obtained in the corresponding tests (1-3) on the y axis. Typically, each test (1-3) is performed for the same input data (e.g., x₁). If the difference between the measurement result of the consecutive tests (that may be developing over time as the line of codes of the software module 140 grows) shows a deviation from the expected values (e.g., the expected value may be 1 or 2% increase in measurement result after every 24 hrs for the same input data) a potential issue with scalability may be detected. For example, if y₂ is 1 or 2 percent higher than y₁ then expected or linear behavior may be determined. However, as illustrated in FIG. 4, y₃ may be 10 or 20 percent higher than y₂ then the increase is not as expected (1 or 2 percent) and the non-linear relation or the potential issue with the scalability may be detected. Essentially, it may be determined that in the last 24 hrs (i.e., from test 2-test 3) the lines of code that are included may causing scalability issues and the corrective action(s) may be taken accordingly.

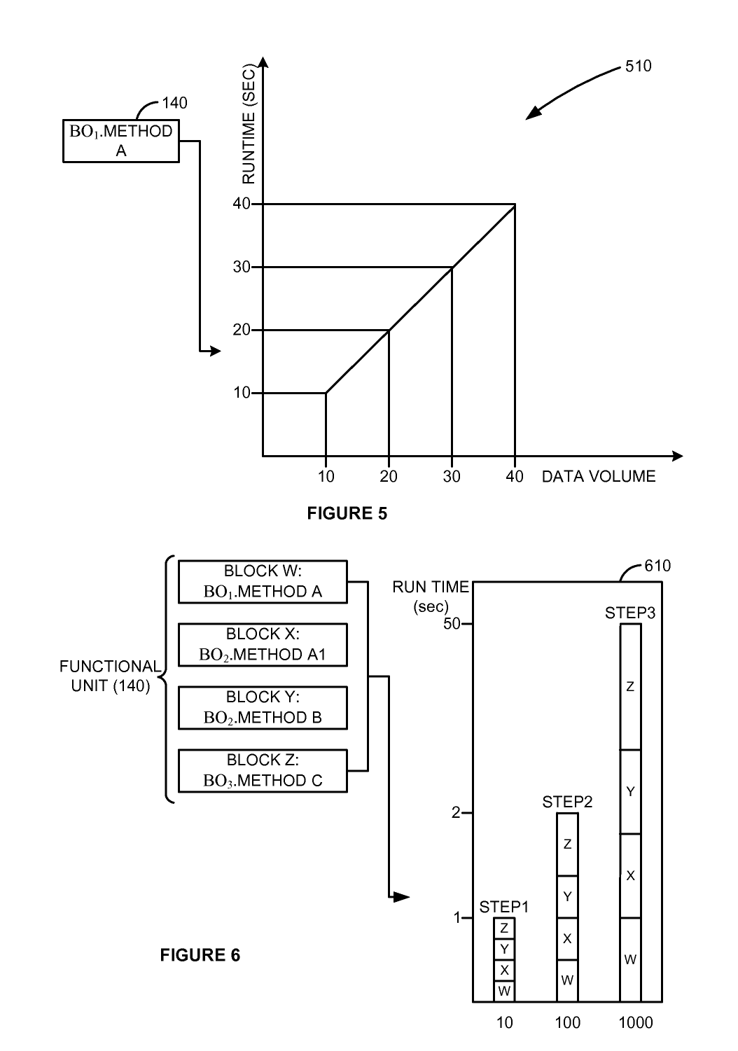

FIG. 5 illustrates an exemplary graph representing the behavior of an exemplary software module 140. The software module 140 may be a simple software module that comprises a method ‘A’ of a Business Object BO₁. The method ‘A’ of the BO₁ is investigated and measured in detail (tested) by the testing tool 130. Essentially, the method ‘A’ is executed for each input data from the set of input data (10, 20, 30, and 40). For example, the method ‘A’ is first executed for the first input data 10 (objects) and the corresponding value of the runtime (i.e., time taken by the method ‘A’ to execute 10 objects) is captured (e.g., 10 seconds), then the method ‘A’ is executed for the second input data 20 (objects) and the corresponding value of the runtime is captured (e.g., 20 seconds), and so on. A graph 510 may be generated using the set of input data (i.e., 10, 20, 30, and 40) and the captured value of measurement results or runtime (e.g., 10 seconds, 20 seconds, 30 seconds, and 40 seconds), as illustrated in FIG. 5. The graph is linear (includes a perfect line) and therefore, it may be determined that the method ‘A’ behaves linearly (scales) relative to the set of input data (10, 20, 30, and 40) and there is no requirement of optimization process, for the method ‘A’, at the moment. The test is performed repeatedly (on the regular basis) or as the development of the software module 140 progresses (as the line of codes keep on increasing).

FIG. 6 illustrates another exemplary graph representing the behavior of an exemplary software module 140. The software module 140 may be the functional unit (scenario) formed by a plurality of methods from a plurality of business objects (BOs). The software module 140 (functional unit) may be a part of the developing software application meant for generating ‘business documents’. The software module 140 may be meant for generating ‘invoices’. The software module 140 may include a method ‘A’ (i.e. confirmation) from a BO₁ (BO purchase order) a method ‘A1’ (create delivery) from a BO₂ (delivery), a method ‘B’ (search for supplier) from the BO₂, and a method ‘C’ (create) from a BO₃ (invoice). The software module 140 is executed for each input data 10, 100, and 1000. Essentially, the methods A, A1, B, and C are first executed for the first input data (10), then for the second input data (100), and then for third input data (1000). The value of an overall runtime (time taken by the methods A, A1, B, and C collectively) for each input data may be captured. For example, the overall runtime may is be 1.00 second for the first input data (10), 2.000 seconds for the second input data (100), and 50.000 seconds for the third input data (1000). The overall runtime is a combination of runtime of each of the methods A, A1, B, and C. Essentially, the runtime of each method may also be captured and represented by different blocks. For example, in a graph 610, a block ‘W’ represents the runtime of method ‘A’ of BO₁, a block ‘X’ represents the runtime of method ‘A1’ of BO₂, a block ‘Y’ represents the runtime of method ‘B’ of BO₂, and a block ‘Z’ represents the runtime of method ‘C’ of BO₃. Each step of the graph 610, i.e., step 1 (executed for the first input data, 10), step 2 (executed for the second input data, 100), and step 3 (executed for the third input data, 1000) includes the entire functional unit or the software module 140 (i.e., blocks W, X, Y, and Z). The graph 610 indicates that the relation of the measurement results (1.00 second, 2.000 seconds, and 50.000 seconds) relative to the set of input data (10, 100, and 1000) behavior of the software module 140 is non-linear. Essentially, it may be analyzed that the overall runtime (1.00 (step 1), 2.000 (step 2), and 50.000 (step 3)) have not increased proportional to the set of input data (10, 100, and 1000), therefore the relation is non-linear.

Once it is determined that the relation is non-linear, the runtime of each method A, A1, B, and C (blocks W, X, Y, and Z) may be analyzed for each step (input data) to determine which method is running non-linearly. It may be analyzed that the behavior of block Z (method C of BO₃) is non-linear and that the block Z has maximum amount of runtime (refer size of block Z). Therefore, it may be concluded that the method C of BO₃ is required to be investigated for non-linearity. The method C of BO₃ may be tested and corrective action may be initiated, as discussed above. In one embodiment, the responsible party that developed method C of BO₃ may be informed.

In the above example, during testing, the parameters related to each input data (objects) are the same, only the number of the input data (objects) is changing at each step (1-3). For example, if the software module 140 is for a ‘sales order creation’ then first the software module 140 is executed to create 10 sales order, then 100 sales order, and at last 1000 sales order, however, the other parameters related to each sales order, e.g., party name, locations, product, etc., are the same for each step (1-3). In one embodiment, the test may be performed by changing some other parameter in each step (1-3) while keeping the number of objects (input data) same at each step (1-3) to confirm that the software module 140 scales in all parameterization. In another embodiment, the tests may be performed by keeping the set of input data (x₁, x₂, . . . , xₙ) 150 same in each test (step 1-step 3) while changing at least one parameter related to the computer 120 (e.g., a processor on which the software module 140 executes) in each test (step 1-step 3) to confirm that the software module 140 scales in all parameterization. In yet another embodiment, the relation of the measurement results relative to the set of input data (x₁, x₂, . . . , xₙ) 150 may be stored, as a history of behavior, in a storage device for future analysis (reference).

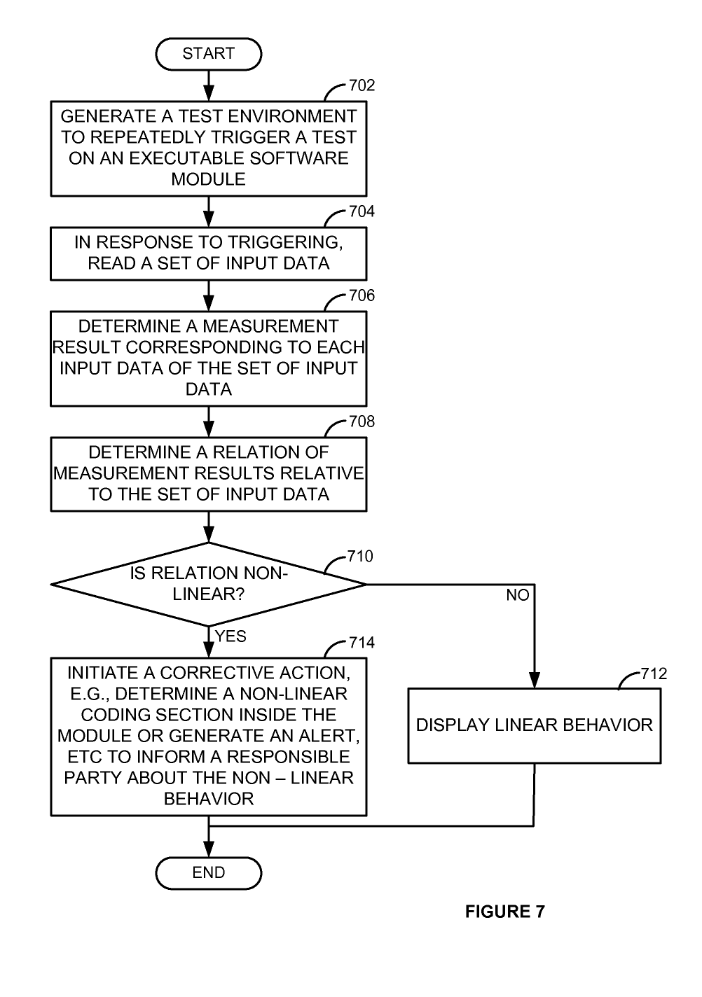

FIG. 7 is a flowchart illustrating a method for testing the software module 140 during the development phase using the testing tool 130. The testing tool 130 generates the test environment to repeatedly trigger the test on the software module 140 at step 702. Once the test is triggered, the testing tool 130 reads the set of input data (x₁, x₂, . . . , xₙ) 150 at step 704. The set of input data (x₁, x₂, . . . , xₙ) 150 may be predefined. The testing tool 130 determines the measurement result corresponding to each input data of the set of input data (x₁, x₂, . . . , xₙ) 150 at step 706. The relation of the measurement results relative to the set of input data is evaluated at step 708. The relation may be linear or non-linear. If the linear relation is determined (step 710: NO) the testing tool 130 displays the linear relation on the computer 120 at step 712. If the relation is non-linear (step 710: YES) the corrective action is initiated by the testing tool 130 at step 714. In one embodiment, the corrective action includes automatically executing the workflow to identify the non-linear coding section(s) within the software module 140 and sending the email to the responsible party about the identified non-linear coding section(s).

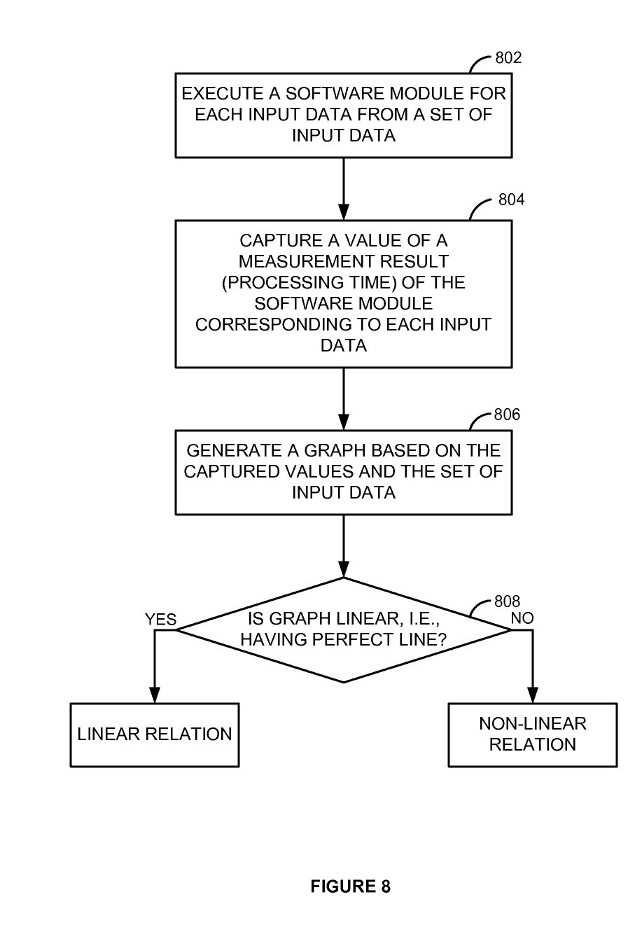

FIG. 8 illustrates steps for determining the relation of the measurement results relative to the set of input data (x₁, x₂, . . . , xₙ) 150 using the graphical approach. The software module 140 is executed for each input data (x₁, x₂, . . . , xₙ) 150 at step 802. The value of the measurement result corresponding to each input data (x₁, x₂, . . . , xₙ) 150 is captured at step 804. The relation of the measurement result relative to the set of input data (x₁, x₂, . . . , xₙ) 150 is determined by generating the graph. The graph is generated between the captured values of the measurement result (y₁, y₂, . . . yₙ) and the set of input data (x₁, x₂, . . . , xₙ) 150 at step 806. The graph may be linear (including the perfect line) or non-linear (including the non-perfect line, e.g., curves). If the graph is non-linear (step 808: NO) the non-linear relation is determined. Alternately, if the graph is linear (step 808: YES), the linear relation is determined. In one embodiment, the graph may be displayed on the user interface device.

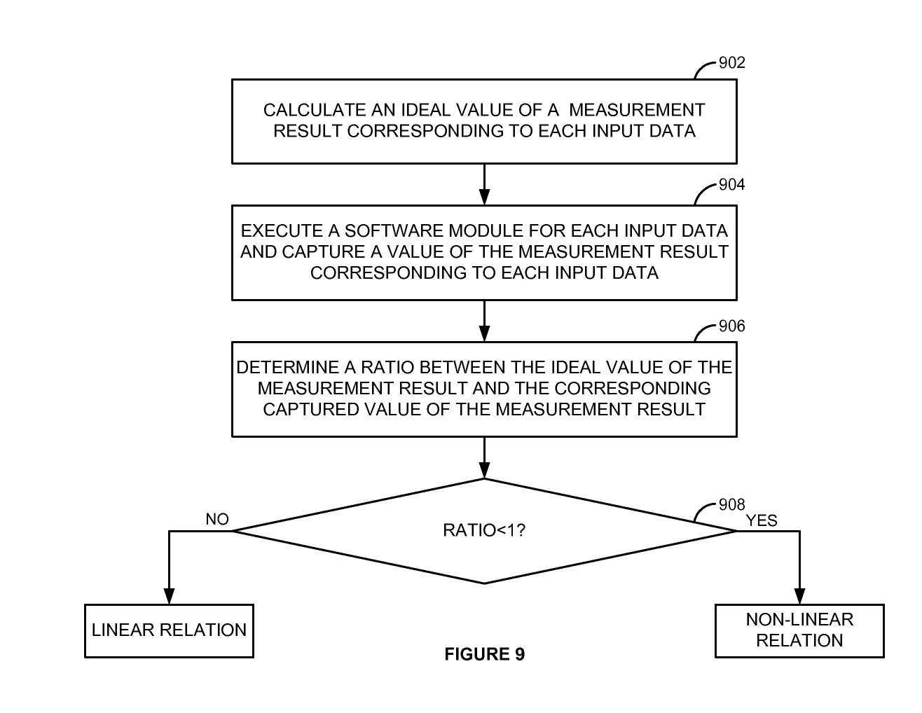

FIG. 9 illustrates steps for determining the relation of the measurement results relative to the set of input data (x₁, x₂, . . . , xₙ) 150 using the mathematical approach. In the mathematical approach, an ideal value of the measurement result is calculated corresponding to each input data (x₁, x₂, . . . , xₙ) 150 at step 902. Essentially, the ideal values of measurement result (y₁′, y₂′, . . . , yₙ′) is calculated by using the formula yᵢ′=axᵢ+b, as discussed above. The software module 140 is executed for each input data (x₁, x₂, . . . , xₙ) and the value of the measurement result corresponding to each input data (x₁, x₂, . . . , xₙ) is captured at step 904. The relation of the measurement result relative to the set of input data (x₁, x₂, . . . , xₙ) 150 is determined by determining the ratio. The ratio is determined between the ideal values of the measurement result (y₁′, y₂′, . . . , yₙ′) and the corresponding captured values of the measurement result (y₁′, y₂′, . . . , yₙ′), i.e., the ratio (y₁′/y₁, y₂′/y₂, . . . , yₙ′/yₙ) is determined at step 906. Each ratio is compared to the numerical value 1 at step 908. If one or more ratio is less than 1, i.e., the captured value of the measurement result is not equal to the corresponding ideal value (step 908: YES) the non-linear relation is determined. Alternately, if each ratio is equal to or greater than 1 (step 908: NO), the linear relation is determined.

The linear relation of the measurement results relative to the set of input data (x₁, x₂, . . . , xₙ) 150 indicates that the software module 140 is scalable, i.e., the performance of the software module 140 may be predicted under the varying conditions/environment. For example, if the software module 140 runs (executes) linear and it takes 10 seconds to generate 10 objects using a single processor then it may be predicted that if one more processor is included the rate of generation would get doubled. Alternately, if the software module 140 runs non-linearly (randomly) then the performance of the software module 140 cannot be predicted. Therefore, the linearity is an important KPI (key performance indicator) that indicates whether the software module 140 or the software application is scalable (running linear).

The investigation of linearity, as development of the software application progresses, ensures proper identification of problems (e.g., non-linear coding section) and its rectification in right time. The software modules if running linear further ensures that the behavior of the software application, developed from the software modules, would also be linear (scalable). Therefore, the linearity can be used as a fundamental KPI, independent of development phase, to measure the scalability of the software application from the very beginning of the development phase. Again, the testing of linearity from the very beginning of the development phase enables identifying the errors precisely and accurately that might be difficult to identify after development. Importantly, the parallel execution of development and testing (running in background) saves time and effort that may be consumed, in investigation and correction (optimization), after development.

Additionally, if after development, it is analyzed that the application scales, however the application is not performance compliant, e.g., the runtime of the application is higher than expected, then the history of the behavior (stored in the memory device) may be analyzed to track the point of development where the runtime got increased. Therefore, the user can easily track the section of code causing runtime issues.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

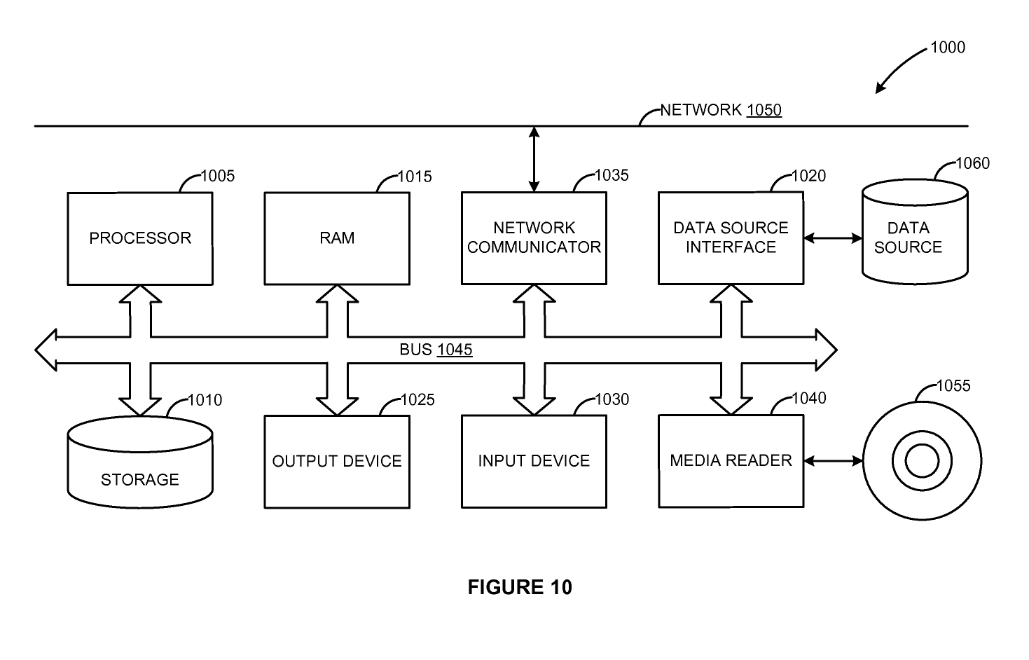

FIG. 10 is a block diagram of an exemplary computer system 1000. The computer system 1000 includes a processor 1005 that executes software instructions or code stored on a computer readable storage medium 1055 to perform the above-illustrated methods of the invention. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. The stored instructions may be further compiled to generate other representations of the instructions and dynamically stored in the RAM 1015. The processor 1005 reads instructions from the RAM 1015 and performs actions as instructed. According to one embodiment of the invention, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
generate a test environment to repeatedly trigger a test on a software module;
in response to triggering, read a set of input data;
evaluate a measurement result corresponding to each input data of the set of input data;
determine a relation of the measurement results relative to the set of input data, wherein the relation comprises one of linear and non-linear; and
initiate a corrective action for the software module if the relation is non-linear.

2. The article of manufacture of claim 1, wherein the test is triggered responsive to a change in the executable software module.

3. The article of manufacture of claim 1, wherein the test is triggered at a predefined time interval and wherein the predefined time interval is modifiable by a user.

4. The article of manufacture of claim 1, wherein the software module comprises at least one of a function, a table, a class, an interface, a method, a user interface, an object generated by at least one of the class and the interface, a business object, and a functional unit generated by a plurality of business objects to perform a specific task.

5. The article of manufacture of claim 1, wherein the set of input data is a number of objects to be processed by the software module.

6. The article of manufacture of claim 1, wherein the set of input data comprises predefined values.

7. The article of manufacture of claim 6, wherein the predefined values are modifiable by a user.

8. The article of manufacture of claim 1, wherein the measurement result is a resource consumption that comprises one of a response time, a CPU utilization, a memory consumption, a database time, a database byte transfer, and a CPU runtime.

9. The article of manufacture of claim 1, wherein the relation of the measurement results relative to the set of input data is determined by:
executing the software module for each input of the set of input data;
capturing a value of the measurement result corresponding to each input of the set of input data; and
generating a graph based on the captured values and the set of input data, wherein the non-linear relation is determined if the graph is non-linear.

10. The article of manufacture of claim 9, wherein the non-linear graph is defined by a polynomial function which is non logarithmic.

11. The article of manufacture of claim 9, wherein the generated graph is displayed on a user interface device.

12. The article of manufacture of claim 1, wherein the corrective action comprises at least one of the following:
executing a workflow to:
identify one or more non-linear code sections within the software module;
and
inform a responsible party about the identified one or more non-linear code sections;
and
generating an alert to inform the responsible party about the non-linear relation of the measurement results relative to the set of input data.

13. The article of manufacture of claim 12, wherein the workflow is executed automatically and an email is sent automatically to the responsible party about the identified one or more non-linear code sections.

14. A computerized method for controlling performance and scalability of a software module during development phase of a software application, the method comprising:
generating a test environment to repeatedly trigger a test on a software module;
in response to triggering, reading a set of input data;
evaluating a measurement result corresponding to each input data of the set of input data;
determining a relation of the measurement results relative to the set of input data, wherein the relation comprises one of linear and non-linear; and
initiating a corrective action for the software module if the non-linear relation is determined.

15. The method of claim 14 further comprising one of the following:
triggering the test at a predefined time interval; and
triggering the test responsive to a change in the software module.

16. The method of claim 14, wherein the corrective action further comprises executing a workflow to identify one or more non-linear code sections within the software module and to inform a responsible party about the identified one or more non-linear code sections.

17. The method of claim 14, wherein determining the relation of the measurement results relative to the set of input data comprises:
executing the software module for each input data;
capturing a value of the measurement result corresponding to each input data; and
generating a graph based on the captured values and the set of input data, wherein the non-linear relation is determined if the graph is non-linear.

18. The method of claim 17 further comprising displaying the generated graph on a user interface device.

19. A computer system for controlling performance and scalability of a developing software application, comprising:
a memory to store a program code;
a processor communicatively coupled to the memory, the processor configurable to execute the program code to:
generate a test environment to repeatedly trigger a test on a software module;
in response to triggering, read a set of input data;
evaluate a measurement result corresponding to each input data from the set of input data;
determine a relation of the measurement results as one of linear and non-linear relative to the set of input data; and
initiate a corrective action for the software module if the non-linear relation is determined.

20. The computer system of claim 19, wherein the processor is further configurable to:
trigger the test automatically either at a predefined time interval or responsive to a change in the software module; and
identify one or more non-linear coding section within the software module and automatically inform a responsible party about the identified one or more non-linear code sections.
